(19) United States
(12) Patent Application Publication
(10) Pub. No.: US 2008/0076651 A1
(43) Pub. Date: Mar. 27, 2008

(54) ROLLING PIN FOR STORING COOKIE CUTTERS

(75) Inventors: Heather Curtin, Renton, WA (US); Jacob A. Marks, Chelsea, MA (US)

Correspondence Address: BLACK LOWE & GRAHAM, PLLC, 701 FIFTH AVENUE, SUITE 4800, SEATTLE, WA, 98104, US

(73) Assignee: Progressive International Corp., Kent, WA (US)

(21) Appl. No.: 11/861,976

(22) Filed: Sep. 26, 2007

Related U.S. Application Data
(60) Provisional application No. 60/827,003, filed on Sep. 26, 2006.

(51) Int. Cl. A21C 3/02

(52) U.S. Cl. 492/14

(57) ABSTRACT

The preferred form of the present invention is a rolling pin having a hollow center portion that is sized and configured to receive and store one or more cooking implements such as a plurality of cookie cutters. The cookie cutters are configured to fit within the interior of the rolling pin. The rolling pin includes two handles, and one or both of the handles is removable to allow the cookie cutters or other implements to be either stored or removed for use.

### PRIORITY CLAIM

This application claims the benefit of prior U.S. Provisional Application Ser. No. 60/827,003, filed Sep. 26, 2006, the content of which is hereby incorporated by reference.

### FIELD OF THE INVENTION

This invention relates generally to rolling pins and cookie cutters.

### BACKGROUND OF THE INVENTION

Storage space is often difficult to find in the modern kitchen. The number of specialized tools and appliances compounds the problem. It is difficult to organize kitchen tools such that they will be readily available when needed. Cookie cutters, for example, come in a variety of shapes. However, they are small and often hard to find at the bottom of a drawer or at the back of a cabinet. It is inconvenient to locate each cookie cutter in a set each time the cookie cutters are used.

### SUMMARY OF THE INVENTION

The preferred form of the present invention is a rolling pin having a hollow center portion that is sized and configured to receive and store a plurality of cookie cutters. Likewise, the cookie cutters are configured to fit within the interior of the rolling pin. The rolling pin includes two handles, and one or both of the handles is removable to allow the cookie cutters to be either stored or removed for use.

In alternate embodiments, other cooking implements such as measuring spoons or measuring cups may be stored within the rolling pin.

### BRIEF DESCRIPTION OF THE DRAWINGS

Preferred and alternative embodiments of the present invention are described in detail below with reference to the following drawings:

FIG. 1A is a perspective view of a rolling pin and cookie cutters, with the cookie cutters shown outside the rolling pin;

FIG. 1B is a perspective view of the rolling pin of FIG. 1A, with one handle removed and the cookie cutters stored inside the rolling pin;

FIG. 1C is a perspective view of the rolling pin of FIG. 1A, shown with the cookie cutters stowed and the handles attached; and

FIG. 2 is an exploded view of the handle of the rolling pin illustrated in FIGS. 1A-1C.

### DETAILED DESCRIPTION OF THE PREFERRED EMBODIMENT

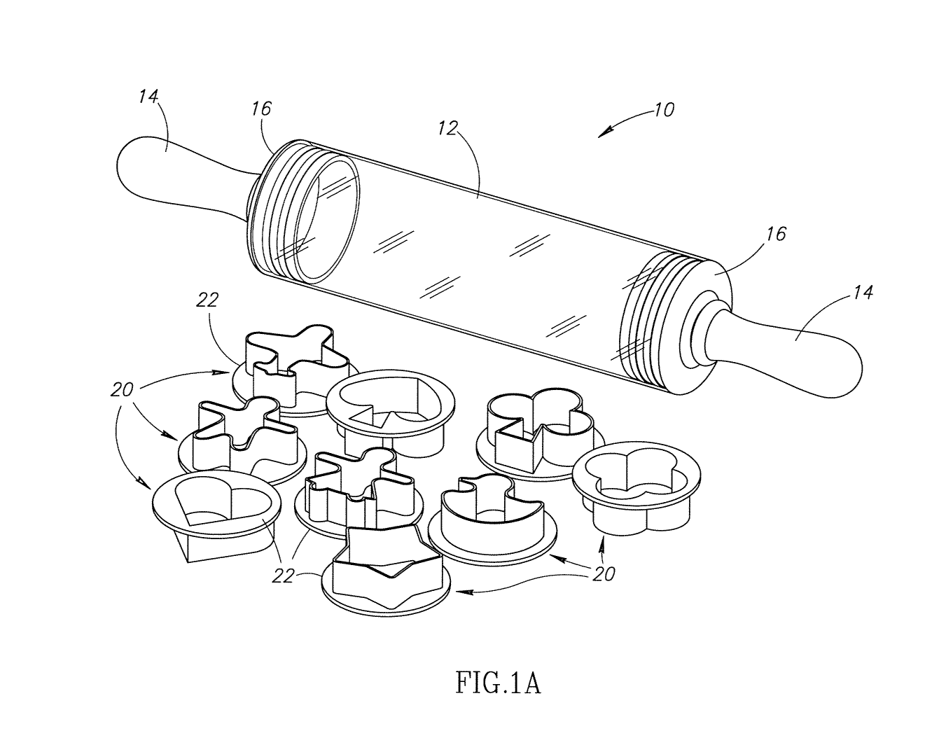

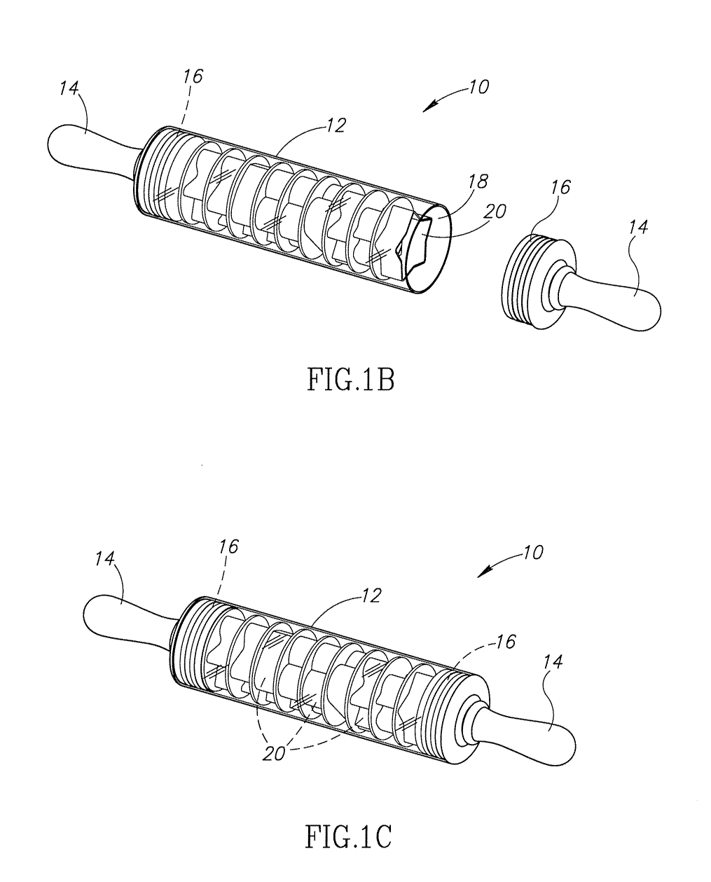

Referring to FIGS. 1A-1C, a rolling pin 10 includes a roller 12, two handles 14, and two handle mounts 16. The roller 12 defines cavity 18 extending therethrough. In the preferred embodiment, the cavity 18 extends completely through the roller 12. However, other embodiments may include a cavity 18 extending through only one end of the roller 12.

A plurality of cookie cutters 20 are sized to fit within the cavity 18. The roller 12 is preferably formed of a transparent material such that the cookie cutters 20 are visible when positioned within the cavity 12, although the roller may be made from wood, metal, stone, ceramic, or other materials. Likewise, the roller may have external layers of silicone or other materials.

The cookie cutters 20 may include a border 22 that is slightly smaller than the diameter of the cavity 18, such that the cookie cutters 20 may be placed within the cavity 18 in an orderly column, as shown in FIGS. 1B and 1C. The border 22 may also reduce movement of the cookie cutters 20 within the cavity 18 in order to reduce rattling when the roller 12 is used to roll out dough. In the example shown, the border comprises a circular flange having a diameter approximately equal to that of the internal diameter of the cavity 18. When stored, a central axis of the cavity is aligned with the centers of the circular flanges. In alternate forms, the border may be shaped differently including, for example, a square, pentagonal, or other shape. A similar mating internal cross-section for the cavity 18 is preferred, to hold the cutters in position.

After the rolling pin 10 and cookie cutters 20 have been used and cleaned, one or both of the handle mounts 16 may be removed to insert the cookie cutters 20 into the cavity 18, as shown in FIG. 1B. The handle mount, or mounts, 16 may then be replaced to secure the cookie cutters 20 within the cavity 18.

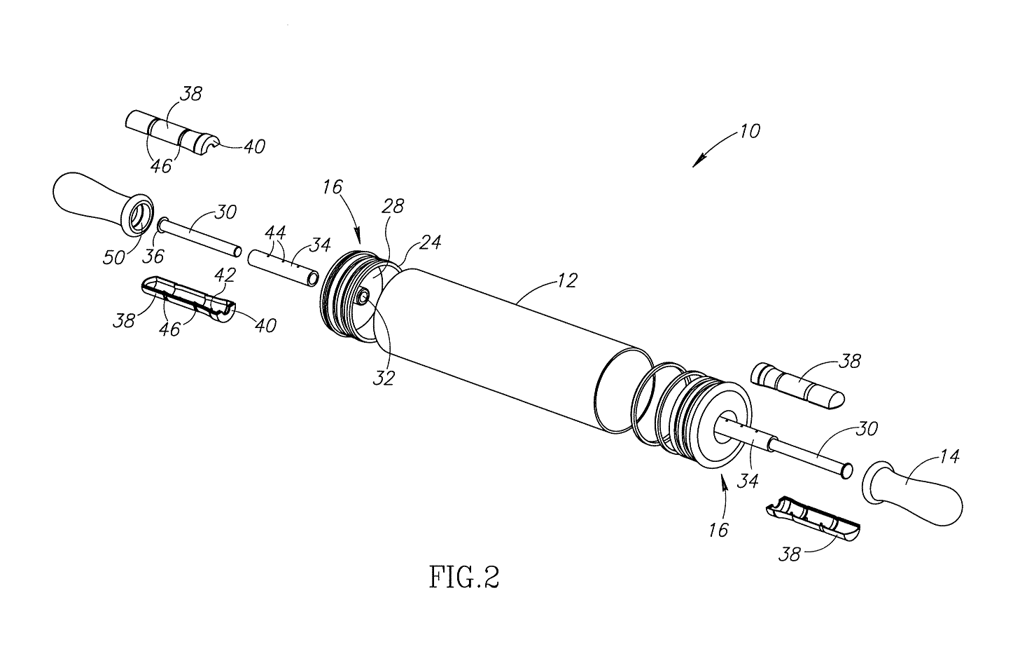

Referring to FIG. 2, the example handle mounts 16 include a plug portion 24 sized to fit within the ends of the cavity 18. One or more seals, such as o-rings may surround the plug portion 24 to maintain the plug portion 24 within the cavity 18 due to friction. The o-rings are typically formed of a resilient material such as rubber. A cap portion 28 of the handle mount 16 secures to the plug portion 24 and covers the opening of the cavity 18. A lip may be formed on the cap portion 28 to abut the end of the roller when the handle mount 16 is inserted within the cavity.

The handle 14 rotatably mounts to the cap portion 28. In the illustrated embodiment, a pin 30 rotatably connects the handle 14 to the cap portion 28. The pin 30 rotatably mounts to at least one of the cap portion 28 and the handle 14 and fixedly or rotatably attaches to the other of the cap portion 28 and handle 14. In the illustrated embodiment, the pin 30 engages an aperture 32 formed in the cap portion 28 by means of a press fit such that the pin 30 is not readily removable from the aperture 32 and is not substantially rotatable.

In the illustrated embodiment, the pin 30 mounts within an inner sleeve 34 inserted within the handle 14. The pin 30 includes a head 36 such that the inner sleeve 34 is captured between the head 36 and the cap portion 28. The inner sleeve 34 may be retained within the handle 14 by a number of means, including glue, fasteners, a press fit, or the like. In the illustrated embodiment, first and second outer sleeve halves 38 secure the inner sleeve 34 within the handle 14. The outer sleeve halves 38 include flanges 40 which cooperate to form an aperture that encircles the pin 30 but is too small for the sleeve 34 to pass through.

The outer sleeve halves 38 may also include one or more radially extending pins 42 insertable within one or more apertures 44 formed along the length of the inner sleeve 34 in order to retain the sleeve 34. Alternatively, the inner sleeve 34 may include pins extending into apertures formed in the outer sleeve halves 38.

The outer sleeve halves 38 include one or more circumferential grooves 46 sized to receive one or more corresponding ridges formed in a cavity 50 in the handle 14. In an alternative embodiment, the ridges are formed on the outer sleeve halves 38 and the grooves 46 are formed within the handle 14. The grooves 46 and ridges may extend completely around the circumference of the combined outer sleeve halves or may be located on only a portion of the circumference.

The grooves 46 include a planar surface facing the roller 12. The planar surface engages a mating planar surface on the ridge in order to retain the outer sleeve halves 38 within the handle 14. The ridges include a sloped leading surface to enable the grooves 46 to slide into engagement with the ridges.

The handles may be secured to the roller using a variety of alternate constructions, including caps that screw onto the roller or that lock into place using different mechanical means. Likewise, the internal cavity of the roller may hold other baking items other than cookie cutters including, for example, measuring spoons or cups.

While the preferred embodiment of the invention has been illustrated and described, as noted above, many changes can be made without departing from the spirit and scope of the invention. Accordingly, the scope of the invention is not limited by the disclosure of the preferred embodiment.

We claim:

1. A rolling pin, comprising:
a roller having an internal cavity; and
a cookie cutter stored within the internal cavity.

2. The rolling pin of claim 1, further comprising a first handle attached to a first end of the roller and a second handle attached to a second end of the roller.

3. The rolling pin of claim 2, wherein the first and second handles are removably attached.

4. The rolling pin of claim 2, wherein the first and second handles each further comprise a handle mount, the handle mounts being secured within the internal cavity.

5. The rolling pin of claim 2, wherein the first and second handles are pivotally attached.

6. The rolling pin of claim 1, wherein the roller is transparent.

7. The rolling pin of claim 1, further comprising a plurality of cookie cutters stored within the internal cavity.

8. The rolling pin of claim 1, wherein the internal cavity comprises a central axis and the cookie cutter includes a peripheral circular flange having a center, the center of the circular flange lying substantially on the central axis when the cookie cutter is stored within the internal cavity.

9. The rolling pin of claim 1, further comprising a plurality of cookie cutters stored within the internal cavity, the internal cavity further comprising a central axis and each of the plurality of cookie cutters including a peripheral circular flange having a center, the centers of the circular flanges lying substantially on the central axis when the cookie cutters are stored within the internal cavity.

10. The rolling pin of claim 1, wherein the cookie cutter has a peripheral surface that mates with an internal surface of the internal cavity.

11. A rolling pin, comprising:
a roller having an internal cavity; and
a cooking implement stored within the internal cavity.

12. The rolling pin of claim 11, wherein the cooking implement comprises a cookie cutter.

13. The rolling pin of claim 11, wherein the cooking implement comprises a measuring spoon.

14. The rolling pin of claim 11, wherein the cooking implement comprises a measuring cup.

15. The rolling pin of claim 11, further comprising a first handle attached to a first end of the roller and a second handle attached to a second end of the roller.

16. The rolling pin of claim 15, wherein the first and second handles are removably attached.

17. The rolling pin of claim 15, wherein the first and second handles each further comprise a handle mount, the handle mounts being secured within the internal cavity.

18. The rolling pin of claim 15, wherein the first and second handles are pivotally attached.

19. The rolling pin of claim 11, wherein the roller is transparent.
